(19) United States
(12) Patent Application Publication
(10) Pub. No.: US 2023/0284593 A1
(43) Pub. Date: Sep. 14, 2023

(54) PET UTILITY HYDRATION SYSTEM

(71) Applicant: KAYNINE, LLC, Pasadena, CA (US)

(72) Inventor: GEGHARD OHANIAN, Pasadena, CA (US)

(73) Assignee: KAYNINE, LLC, PASADENA, CA (US)

(21) Appl. No.: 18/199,555

(22) Filed: May 19, 2023

Related U.S. Application Data
(63) Continuation-in-part of application No. 16/428,869, filed on May 31, 2019.

(51) Int. Cl. A01K 27/00; A01K 7/00; A01K 7/02

(52) U.S. Cl. CPC A01K 27/003; A01K 7/005; A01K 7/02

(57) ABSTRACT

Described is a pet hydration system having both a pet leash and a hydration vest. The leash is designed to have an internal tube system that is encased within a nylon sleeve cover. The hydration vest is separately formed to attach with a pet and carry fluid within a bladder for later extraction and intake by the pet. The leash is operable for affixing with the vest and drawing fluid from the bladder and through the dispensing tube. Notably, the leash and its nylon sleeve cover operate to take any pulling stresses from the pet while avoiding damaging the internal tube system.

### CROSS-REFERENCE TO RELATED APPLICATIONS

The present application is a Continuation-in-Part application of U.S. Ser. No.

16/428,869, filed on May 31, 2019, the entirety of which is incorporated herein by reference.

### FIELD OF THE INVENTION

The present invention relates generally to a pet utility hydration system and, more particularly, to a hydration vest that is worn by a pet, such as a dog, and an associated leash.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, when walking a pet, such as a dog, it can be advantageous to don a harness and/or vest on the pet. Often, a pet utility vest is used to carry and dispense plastic waste bags for collection of pet waste, and for carrying the pet waste until it can be disposed of properly. Such a utility vest may also be used for enhancing visibility of the pet during the day and night, and for covering the pet in cold and inclement weather conditions.

It is also recognized in the art that when exercising or walking the pet, the pet will need to be hydrated. Often, this has meant that whoever was walking the animal was also carrying their own water, and water for the animal. Thus, a water-carrying vest for the pet, which contains pockets for the pet to carry its own water bottles is known in the art. Such a design often requires removing a water container from the vest in order to hydrate the animal.

Other proposals have involved pet harnesses and vests. The problem with these vests is that they do not fit comfortably on the pt. Also, they do not have a convenient means to dispense and retain the liquid for watering the pet. Even though the above cited pet vests meet some of the needs of the market, a utility hydration pet vest that is worn by a pet, such as a dog, for protection, marking, and carrying objects; whereby a liquid bladder fabricated of polyurethane is integrated in the vest; whereby the liquid bladder comprises a collapsible liquid bowl and liquid tube that fit into the vest so that the pet can be fed liquid from the bowl; whereby the vest may include accessories such as an electronic cooling and heating element.

### SUMMARY OF INVENTION

Illustrative embodiments of the disclosure are generally directed to a utility hydration system having both a pet leash and a hydration vest. The leash comprises an external cover and an internal tube system, and wherein the external cover has a sleeve portion, with the internal tube system having a dispensing tube positioned through the sleeve portion and further comprising an outlet shutoff valve and a pump connected with and between the dispensing tube and outlet shutoff valve. The external cover further comprises a handle, a pump cover encasing the pump therein, and a strap attached to the sleeve portion. Additionally, the hydration vest is adapted to be attached to the strap. The hydration vest having a body portion with a bladder therein. The bladder is operable for holding a fluid and connecting with the internal tube system to dispense fluid from the internal tube system.

In use, the pet hydration vest is worn by a pet, such as a dog, for protection, marking, and carrying water and water holding items. The liquid bladder is fabricated of polyurethane is integrated in the vest; whereby the liquid bladder comprises a collapsible liquid bowl and liquid tube that fit into the vest to conveniently water the pet.

The pet vest comprises a body portion defined by an inner surface that engages the pet when adorned, and an outer surface that faces away from the pet. The body portion is further defined by a shoulder section that forms a pair of openings for the fore legs of the pet to pass through and move freely.

The body portion is further defined by a rear section with an overlaying outside pocket layer. The outside pocket layers is formed together along a dividing line to define an isolated liquid compartment comprising a liquid bladder to carry a liquid, and an isolated utility compartment having access openings for holding a collapsible liquid bowl and liquid tube to conveniently water the pet. The vest may include accessories such as an electronic cooling and heating element.

In one aspect, the utility hydration pet vest, comprises:
a body portion defined by an inner surface and an outer surface,
the body portion further defined by a shoulder section forming a pair of openings, and a rear section having an overlaying outside pocket layer on the outer surface of the body portion,
the outside pocket layer being formed along a dividing line to define an isolated liquid compartment having respective first and second access openings for receiving and storing liquid,
the outside pocket layer further being formed along the dividing line to define an isolated utility compartment having respective a third access opening for receiving and storing a dispensing tube defined by a pump end and a free end in fluid communication with the isolated liquid compartment, a pump operable at the pump end, and a collapsible drinking bowl;
a pair of front fastening straps disposed at the shoulder section of the body portion, the front fastening straps comprising a front detachably attachable end; and
a pair of rear fastening straps disposed at the rear section of the body portion, the rear fastening straps comprising a rear detachably attachable end.

In another aspect, the body portion is fabricated from a nylon, polyester blend.

In another aspect, the body portion is resilient.

In another aspect, the body portion wraps around a dog.

In another aspect, the front legs of the dog pass through the pair of openings.

In another aspect, the divided line is stitched.

In another aspect, the isolated liquid compartment comprises a bladder.

In another aspect, the bladder comprises a polyurethane rubber sheet.

In another aspect, the liquid comprises water.

In another aspect, the front fastening straps comprise a 2 inch polyester webbing material.

In another aspect, the rear fastening straps comprise the polyester webbing material.

In another aspect, the fastening straps comprise a slider adjuster.

In another aspect, the front and rear detachably attachable ends comprise a snap-fit buckle.

In another aspect, the vest further comprises a heating element operable to heat the body portion.

In another aspect, the vest further comprises a cooling element operable to cool the body portion.

One objective of the present invention is to provide a protective vest to a dog that carries a bladder of water for facilitated watering of the pet.

Another objective is to provide a collapsible bowl in the pocket of the vest for retaining water.

Yet another objective is to provide a vest that is quickly installed and operable to be fitted in a few quick motions with snap fit buckles, closures; whereby the design works around limbs and does not require the threading of limbs through the front openings.

Yet another objective is to provide a durable, machine washable fabric.

Yet another objective is to provide heating and cooling elements in the body portion to regulate the temperature of the dog.

Yet another objective is to provide an inexpensive to manufacture pet utility vest.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary utility hydration pet vest donned by a dog, in accordance with an embodiment of the present invention;

FIG. 2 illustrates a perspective view of an exemplary utility hydration pet vest donned by a dog, with the pocket layer aligned with the belly of the dog, in accordance with an embodiment of the present invention;

FIG. 3 illustrates a right side top angle perspective view of the utility hydration pet vest, showing the body portion, pockets, and fastening means, in accordance with an embodiment of the present invention;

FIG. 4 illustrates a perspective view of an exemplary shoulder section of the pet vest, in accordance with an embodiment of the present invention;

FIG. 5 illustrates a perspective view of exemplary liquid retention items, including a collapsible bowl and a dispensing tube, in accordance with an embodiment of the present invention;

FIG. 6 illustrates the dispensing tube used in a leash form with a clip and handle, in accordance with an embodiment of the present invention;

FIG. 7 illustrates a perspective view of the collapsible bowl receiving a liquid from the dispensing tube, in accordance with an embodiment of the present invention;

FIG. 8 illustrates a perspective view showing another embodiment of the vest, in accordance with an embodiment of the present invention;

FIG. 9A is an illustration of an internal tube system as positioned with a leash;

FIG. 9B is an illustration of an external cover operating as a sleeve to contain the tube system therein;

FIG. 9C is an illustration of a fully assembled leash;

FIG. 10A is an illustration of the leash;

FIG. 10B is a close-up illustration of detail A-A of FIG. 10A; and

FIG. 10C is an illustration of the leash in use with a canine.

Like reference numerals refer to like parts throughout the various views of the drawings.

### DETAILED DESCRIPTION OF THE INVENTION

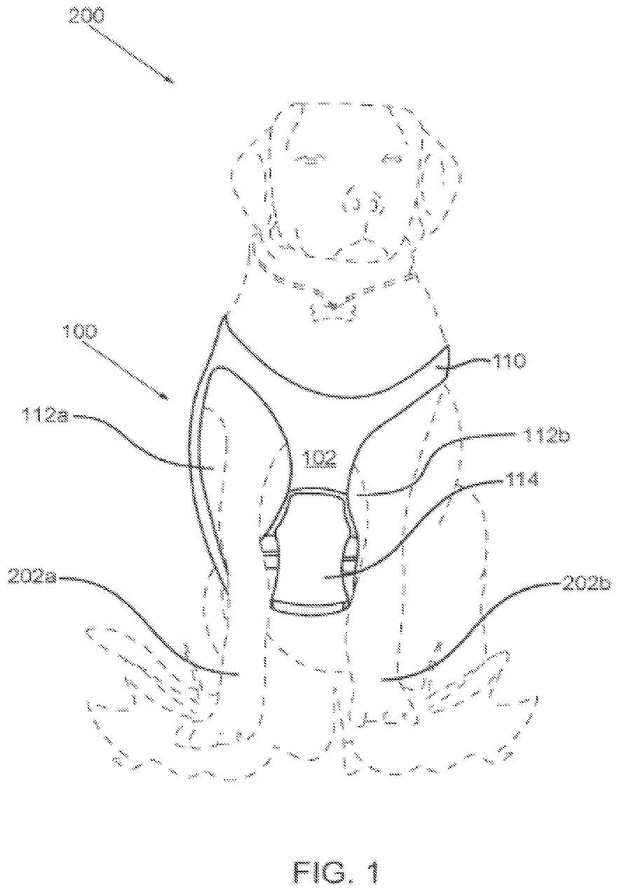

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

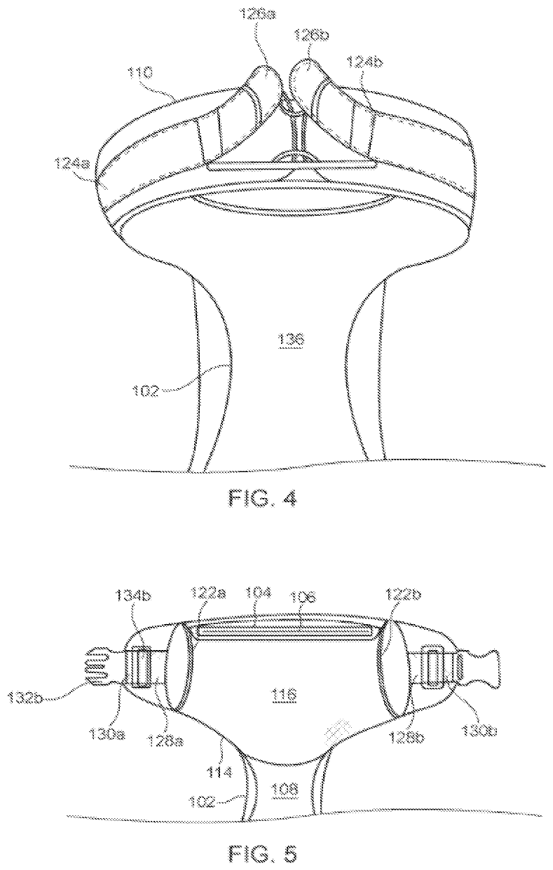

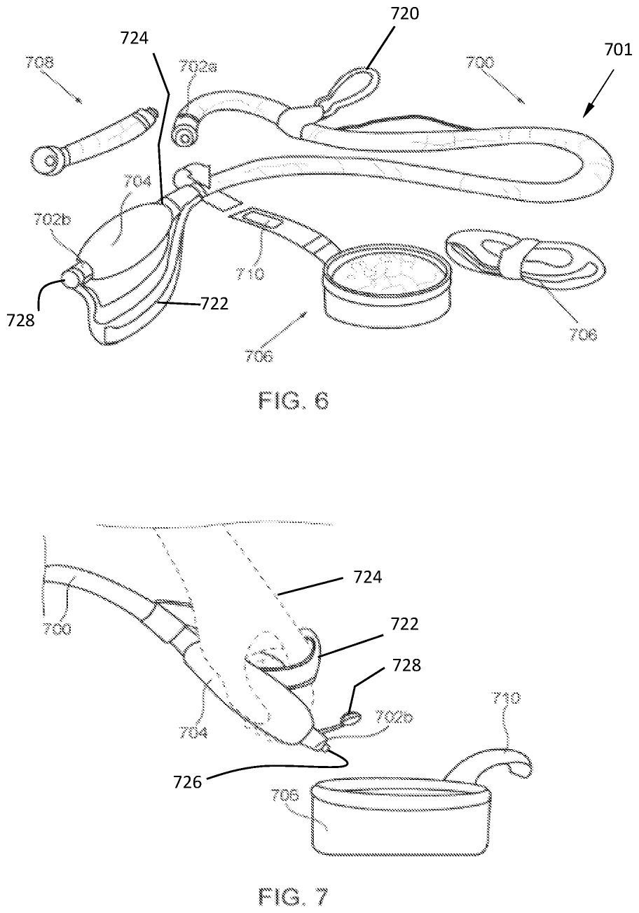

As noted above, the present disclosure is directed to a pet hydration system. The hydration system includes a utility hydration pet vest (as depicted in FIGS. 1-5, and 8) and an associated leash (as depicted in FIGS. 6, 7, and 9A through 10C) specially devised to transfer pulling forces while allowing for hydration of the pet

As shown in FIGS. 1 through 5 and 8, the pet utility hydration vest 100 is a unique body covering for a pet 200, which may include a dog, cat, a livestock animal, and generally any animal that can be maintained. The pet vest 100 covers the back side, shoulder, and part of the front chest of the pet. The pet vest 100 has integrated therein, and overlaying pocket layer 116 divided into a liquid compartment 120 that stores a drinkable liquid; and a utility compartment 104 that stores liquid retention items, such as a collapsible bowl 706, and a dispensing tube 700 that carries the liquid from the liquid compartment 120 to the collapsible bowl 706. In this manner, the pet vest 100 carries its own hydration means.

In alternative embodiments the pet vest 100 can have a heating element and/or a cooling element that are operational in the fabric of the vest to generate heat and reduce heat in the body portion 102 of the vest 100, through various heating and cooling means known in the art. This helps adjust the temperature for the pet, and the temperature regulation of the pet creates a synergy with the hydration means.

As FIG. 1 references, the pet vest 100 comprises a body portion 102 that substantially covers the front shoulder region and back of the pet 200. The body portion 102 materials are breathable and lightweight so that the vest 100 remain adorned on the pet all day under human supervision. The body portion 102 is defined by an inner surface 136 that engages the skin or for of the pet 200. Opposite the inner surface 136 is an outer surface 108 that faces outwardly and away from the pet.

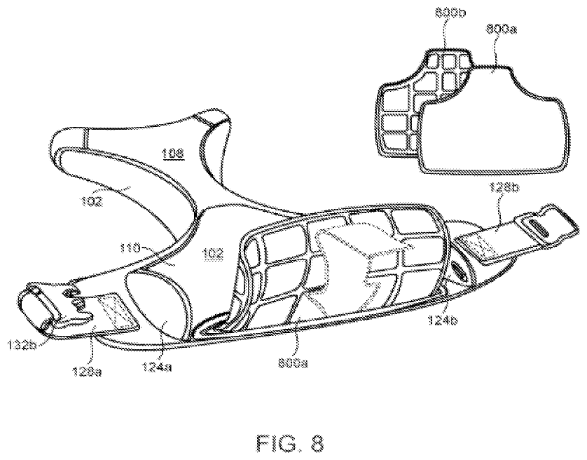

Looking ahead to FIG. 8, the body portion 102 can be formed to include at least one cooling pad 800b and heating pad 800a. This creates greater comfort for the pet 200. In one non-limiting embodiment, the body portion 102 comprises a Cordura® fabric. The Cordura® fabric creates durability for the use and abuse fabrics go through daily. This can include abrasion, scuffs, and tears from the pet 200 rubbing against surfaces, biting, and soiling the fabric. Additionally, the color fastness of the fabric allow for multiple, decorative colors used for ornamental purposes, and functional identification.

The body portion 102 is also defined by a shoulder section 110 that overlays the shoulders, and part of the front limbs 202a-b and chest area of the pet 200. Looking ahead to FIG. 5, the shoulder section 110 forms a pair of openings 112a, 112b that are sized and dimensioned to enable passage of the front limbs 202a, 202b of the pet 200. The openings may be oversized to enable freer movement; or may form a snug fit with the front limbs 202a, 202b. The body portion 102 is further defined by a rear section 114 that overlays back, and part of the hind legs of the pet 200.

In order to secure the body portion 102 around the torso of the pet, as shown in FIG. 1, the pet vest 100 provides a pair of front fastening straps 124a, 124b that extend from opposite sides of the shoulder section 110 of the body portion 102. The front fastening straps 124a-b may include 2″ nylon webbing, and a pair of front detachably attachable ends 126a, 126b. The front detachably attachable ends 126a-b may include a snap-fit buckle 132a that attaches and detaches in in a quick, efficient manner. The front fastening straps 124a-b are also size adjustable through use of a slide adjuster 134a, or other size adjusting buckles known in the art. This allows the width of the shoulder portion 110 to be adjusted to accommodate variously sized and shaped pets. Also, the comfort of the pet 200 can be accommodated more easily through the size adjustability means.

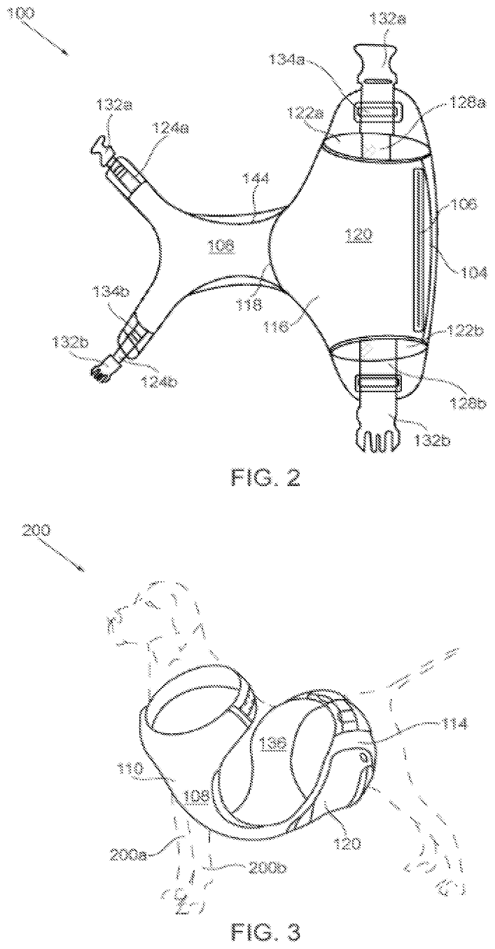

As a complement to the front fastening straps 124a-b, a pair of rear fastening straps 128a, 128b are disposed at the rear section 114 of the body portion 102. The rear fastening straps 128a-b may include 2″ nylon webbing. The rear fastening straps 128a-b extend from opposite sides of rear section 114, and terminates at a pair of rear detachably attachable ends 130a, 130b. The rear detachably attachable ends 130a-b may include a snap-fit buckle 132b that attaches and detaches in in a quick, efficient manner. And as shown in FIG. 2, the rear fastening straps 128a-b are size adjustable through use of a slide adjuster 134b, or other size adjusting buckles 132b known in the art. This allows the width of the rear section 114 to be adjusted to accommodate variously sized and shaped pets 200.

In donning the body portion 102 onto the pet 200, the inner surface 136 is aligned with the back of the pet 200 and draped over rib cage section. The front limbs 202a-b are passed through corresponding front openings 112a-b. The body portion 102 is then aligned across the longitudinal of the back of the pet 200. The front fastening straps 124a-b are pulled down across the chest of the pet 200 and attached front detachably attachable ends 126a-b, i.e, snap-fit buckles 132a-b. Though other fastening means known in the art may also be used.

Next, the rear fastening straps 128a-b are pulled down across the belly of the pet and attached accordingly. At this point, the shoulder section 110 draped over the front region of the pet, while the rear section 114 drapes over the rear section 114. The body portion 102 is also snug, yet comfortably loose, across the back of the pet 200. As discussed below, an overlaying pocket layer 116 orients upwardly across the back of the pet 200, so as to provide access to a liquid and liquid retaining the items. However in alternative embodiments shown in FIG. 3, the body portion 102 is rotated along the torso of the pet 200, so that the pocket layer 116 lies along the belly, rather than the back. In either case, the shoulder section 110 is more forward than the rear section 114 of the body portion 102.

As shown in FIG. 5, the rear section 114 of the body portion 102 comprises an overlaying outside pocket layer 116 that forms on the outer surface 108 of the body portion 102. The outside pocket layer 116 is defined along a dividing line 118, which may be stitched, glued, welded, or detachably fastened in some embodiments. The dividing line 118 defines an isolated liquid compartment 120 having respective first access opening 122a and a second access opening 122b that is sized to enable passage of a liquid in and out of the liquid compartment 120. The first and second access openings 122a-b may have a zipper, a button, or a hook and loop fastener to enable passage thereto. The liquid may include water, or other liquid suitable for the pet to drink.

In one non-limiting embodiment, the isolated liquid compartment 120 is a rubber bladder made up of a polyurethane rubber sheet. The isolated liquid compartment 120 is generally resilient, so that the liquid can be squeezed out of either the first or second access openings 122a, 122b, if necessary. The isolated liquid compartment 120 provides a unique mechanism to dispense the liquid to the pet.

Looking now at FIG. 5, the pet vest 100 also provides multiple liquid retention items to help carry the liquid out of the isolated liquid compartment, and then retain the liquid for the pet to drink from. To carry and store these liquid retention items, the outside pocket layer 116 also forms along the dividing line 118 to define an isolated utility compartment 104 having respective a third access opening 106. In some embodiments, the third access opening 106 may have a zipper, a button, or a hook and loop fastener, so as to enable passage thereto.

The isolated utility compartment 104 may be smaller than the liquid compartment, and serves to receive and store a dispensing tube 700 (shown in FIG. 6) that carries the liquid from the liquid compartment. The dispensing tube 700 is defined by a pump end 702b and a free end 702a that is in fluid communication with the isolated liquid compartment. In some embodiments, a pump 704 is operable at the pump end 702b. The pump 704 allows the user to squeeze and create a vacuum in the dispensing tube 700 to that draws liquid from the liquid compartment to discharge from a cap 728 covered fluid dispensing outlet 726 at the pump end 702b. In one non-limiting embodiment, the pump 704 is a simple inflated bulb that is manually squeezed to draw liquid from the liquid compartment. In another embodiment, the pump is integral with the pump end 702b of the dispensing tube 700.

Additionally, inside the utility compartment a collapsible drinking bowl 706 is contained, and easily remove for retaining the liquid. In some embodiments, the collapsible drinking bowl 706 may include a polyurethane or other material that is resilient to collapse, yet sufficient the rigid to retain the liquid. In yet other embodiments, an extension tube 708 may also be included in the utility compartment to extend the length of the dispensing to. Also, a bowl fastener 710 detachably couples the collapsible bowl dispensing tube 700. FIG. 6 depicts the dispensing tube 700 used in a leash 701 form with a clip 720 and handle 722. The clip 720 is attached proximate the free end 702a to affix the leash 701 and, accordingly, the dispensing tube 700 to the vest, while the handle 722 is attached adjacent to the pump 704 as the pump end 702b of the leash 701 and dispensing tube 700.

As FIG. 7 shows, the liquid can be dispensed directly from the liquid compartment 120 (and its bladder) into the collapsible bowl 706 for the pet 200 to drink from. Also, the handle 722 is attached at the pump end 702b and near the pump 704 so that the handle can be held by a user 724 while walking a dog. A dispensing tube 700, discussed below, carries the liquid from the liquid compartment 120 for dispensing through a pump end 702b. It is significant to note that all the liquid retention items in the utility compartment 104 are resilient and collapsible. In this manner the utility compartment 104 is generally smaller than the liquid compartment 120, which must hold a volume of liquid. However in other embodiments, the pet 200 may be allowed to drink directly from the pump end 702b of the dispensing tube 700.

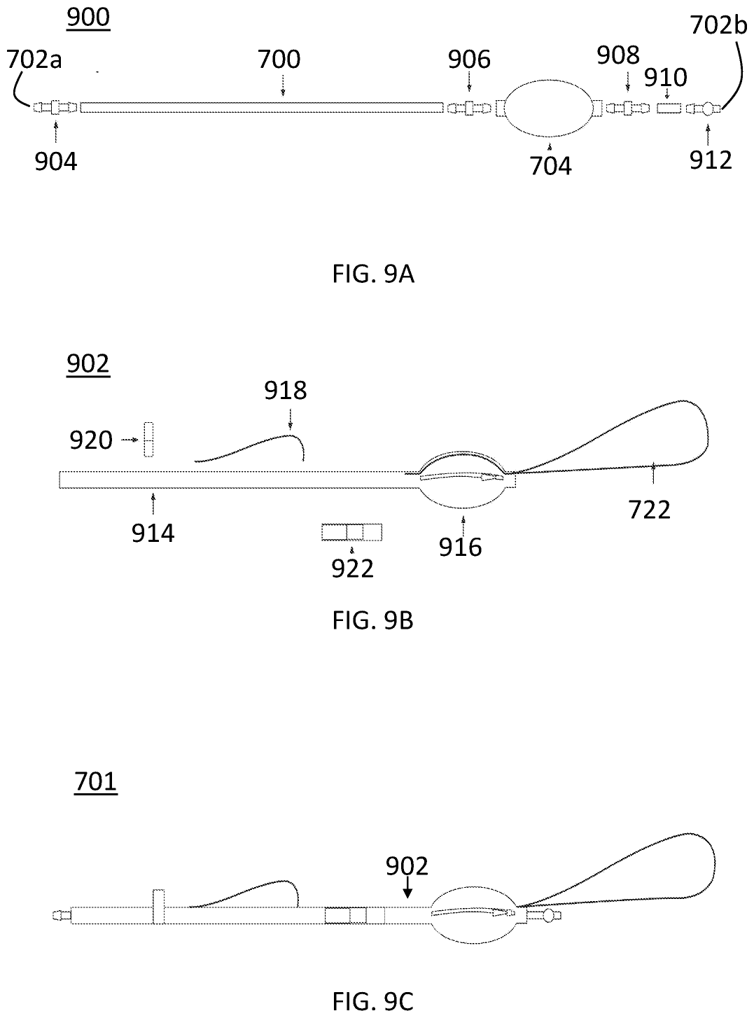

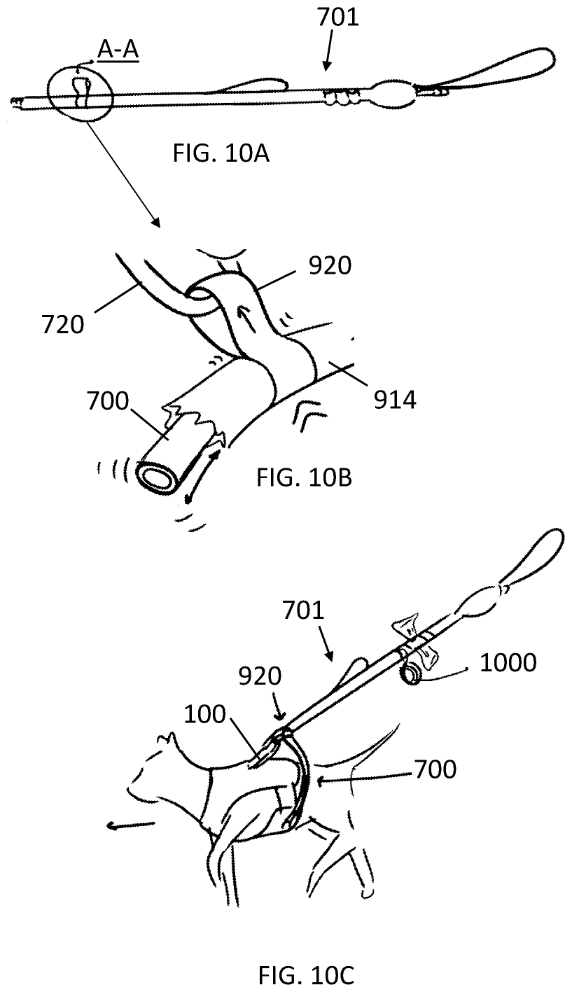

As noted above, a dispensing tube 700 is used in a leash 701. This aspect is further depicted in FIGS. 9A through 10C. Specifically and as shown in FIGS. 9A through 9C, the leash 701 is formed of two main components, an internal tube system 900 (depicted in FIG. 9A) and an external cover 902 (depicted in FIG. 9B). The cover 902 operates as a sleeve to contain the tube system 900 therein. The resulting fully assembled leash 701 is depicted in FIG. 9C. Thus, the dog leash 702 features a tubing system (shown in FIG. 9A) therein that allows dog owners to provide their furry companions with hydration while walking them.

Referring again to FIG. 9A, the tube system 900 includes a dispensing tube 700 formed of any appropriate tube material, non-limiting examples of which include stretchable silicone tubing. The free end 702a of the tube system 900 includes a first connector inlet 904 that can be used to connect the tube 700 with the liquid bladder. A first connector/valve 906 (e.g., one way check valve) is used to connect the tube 700 to the pump 704 (e.g., silicone rubber hand squeeze bulb pump) which can then be used to pump 704 fluid out of the pump end 702b of the tube system 900. Although not required, desirably, a second connector/valve 908 (e.g., one way check valve) is used to connect the pump 704 to a small section of flexible tube 910 that terminates in a connected outlet on/off valve 912 (e.g., stopcock, etc.).

As noted above, the dispensing tube 700 is encased within the cover 902 (as shown in FIG. 9B). The external cover 902 is formed of any suitable material that can be used to encase and protect the tube 700. Desirably, the cover 902 includes a sleeve portion (or sleeve 914) that is made of two layers of high-quality, durable webbing that are sewn together on the outer edges, leaving a gap in the middle where the water tube 700 is assembled and protected. The sleeve 914 continues to a pump cover 916 (e.g., nylon cover with a zipper) that can be used to secure and conceal the pump therein. Affixed with an extending from the sleeve 914 (and/or pump cover 916) is the primary handle 722. Desirably, a secondary grab handle 918 can be affixed along the length of the sleeve 914 (e.g., near the middle). Importantly, a buckle or clip strap 920 is affixed to the sleeve 914 proximate the free end of the tube. For example, the strap 920 is sewn onto the sleeve 914 to take all of the resistance and impact away for the interior tube system when in use. In some aspects, loops 922 (e.g., nylon webbing loops) are affixed with the sleeve 914 to allow for connection of accessories and other components as desired.

For further understanding, FIG. 9C depicts a fully assembled leash 701 in which the tubing system is positioned and secured within the external cover 902. The leash 701 is designed to hold the weight and pulls from a dog without damaging the internal tube system. In other words, pulling forces from the dog are passed through and borne by the cover 902 while the tube remains slack within the cover 902. Note that both the strap 920 and sleeve 914 are desirably formed of a non-stretchable material (such as nylon) to resist stretching and preventing expansion forces from being passed to the tube encased therein. With the external nylon sleeve 914 wrapped around the silicone tube, this allows it to be a multi-functional leash where the open end can be connected to liquid bladder (e.g., water pouch) in order to supply water to the dog on the go.

The importance of the leash 701 and its structure is further depicted in FIGS. 10A through 10C. As shown in FIG. 10B, the tube 700 is allowed to move and slide freely within the sleeve 914. Importantly, because the strap 920 is affixed to the sleeve 914, any tension from the clip 720 when being pulled by a dog is passed directly to the sleeve 914 without stretching the tube 700 (as the tube 700 slides within the sleeve 914 to avoid being stretched and damaged).

Thus, near the nozzle end of the leash 701, there is a strap 920 that is sewn onto the leash 701 webbing and that is used to buckle to the dog's harness. This strap 920 serves as the support system and takes all the pull/pressure from the dog, ensuring that the tube 700 inside the leash 701 does not break or buckle. The webbing sleeve 914 and the tube 700 inside are not joined together, allowing the tubing 700 inside to slide around freely. The sewn loop strap 920 near the nozzle end attaches to a buckle or clip 720 (which is affixed to the dog harness or collar) and acts as the point of resistance, taking all the pull from the dog; hence, doubling as a “leash”(which is only sewn onto the sheath, leaving the tube 700 inside to move freely). This allows the stretchable food grade safe silicone tube 700 inside to be able to stay securely attached to the liquid bladder and not get pulled or disconnected in the process of the dog pulling on the tube/leash 701. If there is slight pull or buckle in the tube 700, it will not damage the tube 700 as it is formed of a stretchable material.

As shown in FIG. 10C, the leash 701 is affixed to the vest 100. The tension is taken by the strap 920 (and from there the sleeve), while the tube 700 extends from the leash 701 to connect with a fluid bladder. Notably, the tube 700 is slack so that it does not get pulled or disconnected from the bladder. Also as depicted is a carry strip 1000, which is a sewn webbing loop or other feature that can be affixed to the sleeve 914 near the pump and can be used to hold the users water bowl, poop bags, or treats, etc.

Further and as can be appreciated by those skilled in the art, using the two-in-one dog leash with a hydration system is simple. First, slip the water pouch (i.e., fluid compartment) into the dog's harness (i.e., the vest). Then, clip the nozzle end of the leash into the fluid compartment. Next, clip the buckle strap to the top of the vest. Finally, grab the handle of the leash and take your dog for a walk. When your dog needs water, simply grab the pump at the handle end and pump water into your dog's collapsible bowl for it to drink. When done, keep walking.

The two-in-one dog leash used in conjunction with a hydration vest offers several advantages over the prior art. For example, it eliminates water waste and the need to carry a separate water bottle, making walks more convenient and comfortable for both the dog and the owner. The vest ensures that the dog stays close and under control while on the go. The hands-free convenience of the leash makes walks more enjoyable for both the dog and the owner.

In other embodiments, the pet vest is unique in providing alternative versions that further improve the conditions of the pet. In one embodiment the pet vest includes a heating element that is operable to heat the body portion. The heating element may include chemical composition integral in the body portion, which can be heated through motion by the pet or by manipulation of the body portion. In other embodiments, the heating element may include an electric blanket having small wires that heat up after being powered by a battery.

Conversely, the pet vest may also include a cooling element operable to cool the body portion. Cooling element may simply include an additional pocket or space in the body portion that contains ice, dry ice, or a chemical that maintains a low temperature.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A pet utility hydration system, the hydration system comprising:
a pet leash, the leash having an external cover and an internal tube system, wherein the external cover has a sleeve portion, and wherein the internal tube system has a dispensing tube positioned through the sleeve portion.

2. The pet utility hydration system as set forth in claim 1, wherein the internal tube system further comprises an outlet shutoff valve and a pump connected with and between the dispensing tube and outlet shutoff valve.

3. The pet utility hydration system as set forth in claim 2, wherein the external cover further comprises:
a handle;
a pump cover encasing the pump therein; and
a strap attached to the sleeve portion.

4. The pet utility hydration system as set forth in claim 3, further comprising a hydration vest adapted to be attached to the strap, the hydration vest having:
a body portion having a bladder therein, the bladder operable for holding a fluid and connecting with the internal tube system to dispense fluid from the internal tube system.

5. The pet utility hydration system as set forth in claim 4, wherein the hydration vest is defined by an inner surface and an outer surface, and further comprises:
the body portion being further defined by a shoulder section forming a pair of openings, and a rear section having an overlaying outside pocket layer on the outer surface of the body portion,
the outside pocket layer being formed along a dividing line to define an isolated liquid compartment having a bladder,
the outside pocket layer further being formed along the dividing line to define an isolated utility compartment having an access opening, the utility compartment operable to receive and store a dispensing tube defined by a pump end and a free end in fluid communication with the bladder;
a pair of front fastening straps disposed at the shoulder section of the body portion, the front fastening straps comprising a front detachably attachable end; and
a pair of rear fastening straps disposed at the rear section of the body portion, the rear fastening straps comprising a rear detachably attachable end;
wherein the pump is disposed at the pump end of the dispensing tube, with the pump end terminating in a fluid dispensing outlet such that water pumped from the fluid dispenser is drawn from the bladder, through the dispensing tube and dispensed from the fluid dispensing outlet, and
a handle attached at the pump end adjacent to the handle so that the handle can be held while walking a dog with the pump maintained adjacent to the handle;
a bowl fastener detachably coupling a collapsible drinking bowl with the dispensing tube.

6. The pet utility hydration system as set forth in claim 5, wherein the body portion is fabricated from a nylon, polyester blend.

7. The pet utility hydration system as set forth in claim 6, wherein the pair of openings in the body portion is provided for the dog's front limbs to pass through.

8. The pet utility hydration system as set forth in claim 7, wherein the divided line is stitched.

9. The pet utility hydration system as set forth in claim 8, wherein the bladder comprises a polyurethane rubber sheet.

10. A pet utility hydration system, the hydration system comprising:
a pet leash, the leash having an external cover and an internal tube system, wherein the external cover has a sleeve portion, and wherein the internal tube system has a dispensing tube positioned through the sleeve portion and further comprises an outlet shutoff valve and a pump connected with and between the dispensing tube and outlet shutoff valve, and wherein the external cover further comprises a handle, a pump cover encasing the pump therein, and a strap attached to the sleeve portion; and
a hydration vest adapted to be attached to the strap, the hydration vest having a body portion having a bladder therein, the bladder operable for holding a fluid and connecting with the internal tube system to dispense fluid from the internal tube system.
